(19) United States
(12) Patent Application Publication
(10) Pub. No.: US 2026/0189978 A1
(43) Pub. Date: Jul. 2, 2026

(54) VEHICLE-MOUNTED COMMUNICATION DEVICE

(71) Applicant: Mitsubishi Electric Corporation, Tokyo (JP)

(72) Inventors: Masao IWATA, Tokyo (JP); Yasuaki TAKIMOTO, Tokyo (JP)

(73) Assignee: Mitsubishi Electric Corporation, Tokyo (JP)

(21) Appl. No.: 18/856,076

(22) PCT Filed: May 20, 2022
(86) PCT No.: PCT/JP2022/020963

§ 371 Date: Oct. 11, 2024

(51) Int. Cl. H04W 28/06; H04W 4/46; H04W 28/10

(52) U.S. Cl. CPC H04W 28/06; H04W 28/10; H04W 4/46

(57) ABSTRACT

A vehicle-mounted communication device prevents loss of received messages which randomly happens. A reception stop determination unit outputs a reception stop signal to a reception unit, if the reception unit is receiving messages and an empty buffer amount is less than a reference capacity which is a capacity to be used to receive the messages for one cycle of an out-of-vehicle communication cycle. A reception restart determination unit outputs a reception restart signal to the reception unit, if the reception unit has stopped receiving the messages and the empty buffer amount is not less than the reference capacity. When the reception unit has acquired the reception stop signal, the reception unit stops receiving the messages, and when the reception unit has acquired the reception restart signal, the reception unit restarts receiving the messages.

### TECHNICAL FIELD

The present disclosure relates to a vehicle-mounted communication device.

### BACKGROUND ART

Technologies relating to vehicle-to-vehicle communication and road-to-vehicle communication intended for the alleviation of traffic congestion, etc. are being developed. In the vehicle-to-vehicle communication, each vehicle transmits own vehicle information to surrounding vehicles. In Basic Safety Message (BSM) defined for messages to be used in the vehicle-to-vehicle communication, an out-of-vehicle communication cycle of transmitting messages is generally set at 100 ms (100 milliseconds). Thus, when messages are continuously received for at least 100 ms or more, messages from surrounding vehicles can be received.

When the number of surrounding vehicles is increased, the amount of messages to be received is increased and load of reception message processing is also increased. In a case where messages cannot be processed due to increased processing load, loss or processing delay of the messages happens, and a Vehicle-to-Vehicle (V2V) application does not normally operate, so that notification to a driver may be delayed. In view of this, a communication device has been proposed in which a degree of importance of a received message is judged on the basis of content of the received message, a packet type flag added to the message, the frequency of reception from the same transmission source, reception power, and the like, determination as to necessity of verification is performed according to the degree of importance, and, if it is determined that the message needs to be verified, verification is performed, whereas, if it is determined that the message does not need to be verified, verification is not performed (e.g., see Patent Document 1).

### CITATION LIST

### Patent Document

Patent Document 1: Japanese Laid-Open Patent Publication No. 2012-100024

### SUMMARY OF THE INVENTION

### Problem to be Solved by the Invention

In the communication device disclosed in Patent Document 1, other-vehicle information included in the received message is analyzed in detail to perform judgement as to priority thereof and whether or not verification is needed is determined, and thus load of processing, for example, detailed analysis and judgement of the content of the received message, is high. Therefore, in a case where the number of surrounding vehicles is increased and processing load is increased, the amount of received messages exceeds an available buffer, and loss of the received messages randomly happens, thus causing a problem that important information may fail to be received.

The present disclosure has been made to solve the above problem, and an object of the present disclosure is to provide a vehicle-mounted communication device which prevents loss of received messages which randomly happens.

### Means to Solve the Problem

A vehicle-mounted communication device according to the present disclosure includes: a reception unit for receiving messages transmitted per out-of-vehicle communication cycle from outside of a vehicle; an other-vehicle information reception unit for acquiring the messages from the reception unit and extracting other-vehicle information from the messages; a reception buffer in which the messages acquired by the other-vehicle information reception unit are temporarily stored; a load state monitoring unit for acquiring reception load information which is load information of the other-vehicle information reception unit, from the other-vehicle information reception unit; and a reception control unit for acquiring the reception load information from the load state monitoring unit and controlling the reception unit. The reception control unit includes a reception stop determination unit for determining whether or not the reception unit should stop reception, and a reception restart determination unit for determining whether or not the reception unit should restart reception. The reception load information includes an empty buffer amount which is an empty capacity of the reception buffer. The reception stop determination unit outputs a reception stop signal to the reception unit, if the reception unit is receiving the messages and the empty buffer amount is less than a reference capacity which is a capacity to be used to receive the messages for one cycle of the out-of-vehicle communication cycle. The reception restart determination unit outputs a reception restart signal to the reception unit, if the reception unit has stopped receiving the messages and the empty buffer amount is not less than the reference capacity. When the reception unit has acquired the reception stop signal while receiving the messages, the reception unit stops receiving the messages, and when the reception unit has acquired the reception restart signal during stop of receiving the messages, the reception unit restarts receiving the messages.

### Effect of the Invention

The vehicle-mounted communication device according to the present disclosure includes; a reception unit for receiving messages transmitted per out-of-vehicle communication cycle from outside of a vehicle; an other-vehicle information reception unit for acquiring the messages from the reception unit and extracting other-vehicle information from the messages; a reception buffer in which the messages acquired by the other-vehicle information reception unit are temporarily stored; a load state monitoring unit for acquiring reception load information which is load information of the other-vehicle information reception unit, from the other-vehicle information reception unit; and a reception control unit for acquiring the reception load information from the load state monitoring unit and controlling the reception unit. The reception control unit includes a reception stop determination unit for determining whether or not the reception unit should stop reception, and a reception restart determination unit for determining whether or not the reception unit should restart reception. The reception load information includes an empty buffer amount which is an empty capacity of the reception buffer. The reception stop determination unit outputs a reception stop signal to the reception unit, if the reception unit is receiving the messages and the empty buffer amount is less than a reference capacity which is a capacity to be used to receive the messages for one cycle of the out-of-vehicle communication cycle. The reception restart determination unit outputs a reception restart signal to the reception unit, if the reception unit has stopped receiving the messages and the empty buffer amount is not less than the reference capacity. When the reception unit has acquired the reception stop signal while receiving the messages, the reception unit stops receiving the messages, and when the reception unit has acquired the reception restart signal during stop of receiving the messages, the reception unit restarts receiving the messages. Therefore, loss of the received messages which randomly happens can be prevented.

### BRIEF DESCRIPTION OF THE DRAWINGS

FIG. 1 is diagram showing the entire configuration of a wireless communication system including vehicle-mounted communication devices according to embodiment 1.

FIG. 2 is a block diagram showing a configuration of each vehicle-mounted communication device according to embodiment 1.

FIG. 3 is a flowchart showing details of a reception control process in the vehicle-mounted communication device according to embodiment 1.

FIG. 4 is a flowchart showing details of a load information acquisition process in the vehicle-mounted communication device according to embodiment 1.

FIG. 5 is a block diagram showing a configuration of a vehicle-mounted communication device according to embodiment 2.

FIG. 6 is a flowchart showing details of a message deletion process in the vehicle-mounted communication device according to embodiment 2.

FIG. 7 is a schematic view showing an example of a hardware configuration of the vehicle-mounted communication device according to embodiment 1 and embodiment 2.

### DESCRIPTION OF EMBODIMENTS

Hereinafter, vehicle-mounted communication devices according to embodiments for carrying out the present disclosure will be described in detail with reference to the drawings. In the drawings, the same reference characters denote the same or corresponding parts.

### Embodiment 1

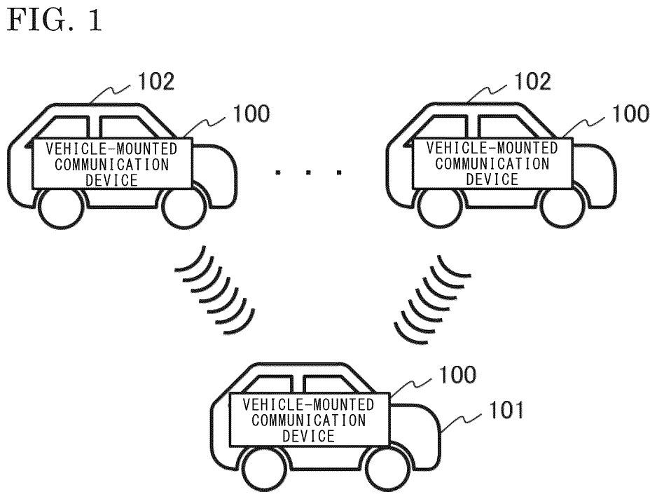

FIG. 1 is a diagram showing the entire configuration of a wireless communication system including vehicle-mounted communication devices 100 according to embodiment 1. An own vehicle 101 and other vehicles 102 are mounted with the vehicle-mounted communication devices 100, and the own vehicle 101 performs wireless communication with a plurality of the other vehicles 102. Each vehicle-mounted communication device 100 has a vehicle-to-vehicle communication function. The vehicle-mounted communication device 100 mounted on the own vehicle 101 generates a transmission message from, for example, own vehicle information such as an own-vehicle position which is the position of the own vehicle 101, an own-vehicle advancing direction which is the advancing direction of the own vehicle 101, and an own-vehicle speed which is the speed of the own vehicle 101, and transmits the transmission message to the other vehicles 102. In addition, the vehicle-mounted communication device 100 receives other-vehicle messages from the other vehicles 102, and uses, in various applications, information on the other vehicles 102 included in the other-vehicle messages. The applications include, for example, an application for judging a possibility of contact with any of the other vehicles 102 and notifying a driver of the possibility. The vehicle-mounted communication device 100 may perform Vehicle-to-X (V2X) communication with the outside of the vehicle, such as road-to-vehicle communication.

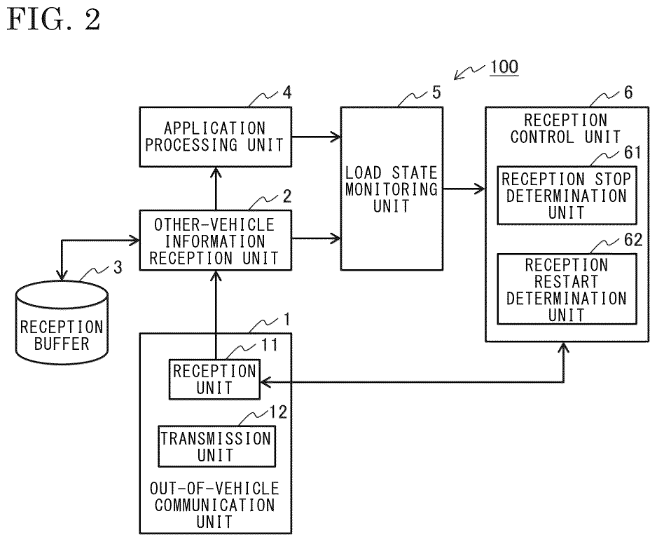

FIG. 2 is a block diagram showing a configuration of the vehicle-mounted communication device 100 according to embodiment 1. The vehicle-mounted communication device 100 includes an out-of-vehicle communication unit 1, an other-vehicle information reception unit 2, a reception buffer 3, an application processing unit 4, a load state monitoring unit 5, and a reception control unit 6. The out-of-vehicle communication unit 1 performs transmission/reception in communication with the outside of the vehicle and performs, for example, transmission/reception in vehicle-to-vehicle communication. The out-of-vehicle communication unit 1 includes a reception unit 11 for receiving messages transmitted per out-of-vehicle communication cycle from the outside of the vehicle, and a transmission unit 12 for transmitting, per out-of-vehicle communication cycle, a message including the own vehicle information to the outside of the vehicle. The out-of-vehicle communication cycle is set at 100 ms, for example. The other-vehicle information reception unit 2 acquires the messages from the reception unit 11, extracts other-vehicle information from the messages, and outputs the other-vehicle information to the application processing unit 4. The reception buffer 3 is provided for temporarily storing therein the messages acquired by the other-vehicle information reception unit 2. When the other-vehicle information reception unit 2 has acquired a plurality of messages from the reception unit 11, the other-vehicle information reception unit 2 temporarily stores the plurality of acquired messages in the reception buffer 3, and takes out the acquired messages one by one from the reception buffer 3 to extract the other-vehicle information therefrom. The application processing unit 4 performs processing for an application on the basis of the other-vehicle information acquired from the other-vehicle information reception unit 2.

The load state monitoring unit 5 acquires reception load information which is load information of the other-vehicle information reception unit 2, from the other-vehicle information reception unit 2, and acquires processing load information which is load information of the application processing unit 4, from the application processing unit 4. The load state monitoring unit 5 outputs the reception load information and the processing load information to the reception control unit 6. The reception control unit 6 includes a reception stop determination unit 61 and a reception restart determination unit 62. The reception stop determination unit 61 checks whether or not the reception unit 11 is receiving messages, and, if the reception unit 11 is receiving messages, checks whether or not the reception load information and the processing load information acquired from the load state monitoring unit 5 satisfy a stop condition. If the stop condition is satisfied, the reception stop determination unit 61 outputs a reception stop signal to the reception unit 11. The reception restart determination unit 62 checks whether or not the reception unit 11 has stopped receiving messages, and, if the reception unit 11 has stopped receiving messages, checks whether or not the reception load information and the processing load information acquired from the load state monitoring unit 5 satisfy a restart condition. If the restart condition is satisfied, the reception restart determination unit 62 outputs a reception stop signal to the reception unit 11. The load state monitoring unit 5 may acquire only the reception load information from the other-vehicle information reception unit 2 and output the reception load information to the reception control unit 6. The reception stop determination unit 61 may check whether or not the reception load information satisfies the stop condition, and the reception restart determination unit 62 may check whether or not the reception load information satisfies the restart condition. When the reception unit 11 has acquired the reception stop signal from the reception stop determination unit 61 while receiving the messages from the outside of the vehicle, the reception unit 11 stops receiving the messages from the outside of the vehicle, and when the reception unit 11 has acquired a reception restart signal from the reception restart determination unit 62 during stop of receiving the messages from the outside of the vehicle, the reception unit 11 restarts receiving the messages from the outside of the vehicle.

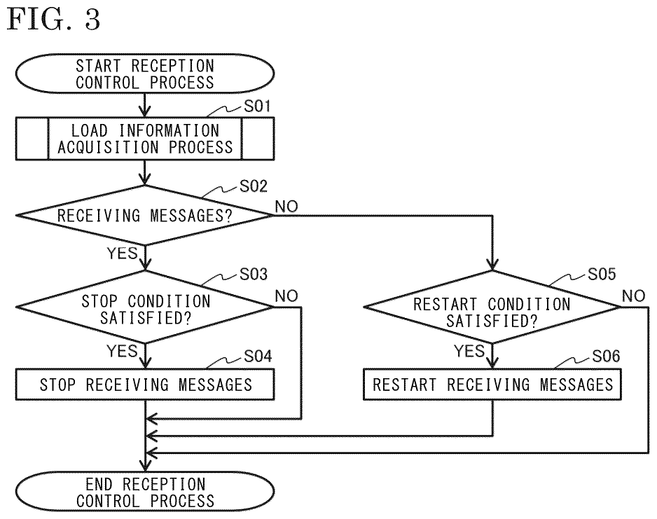

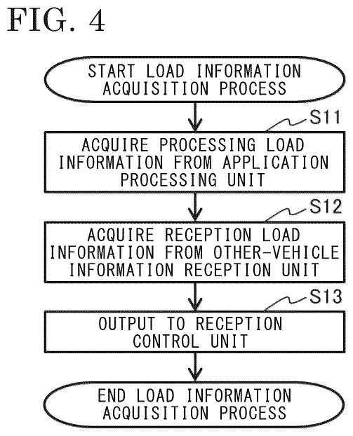

FIG. 3 is a flowchart showing details of a reception control process in the vehicle-mounted communication device 100 according to embodiment 1. In FIG. 3, step S01 is a load information acquisition process. FIG. 4 is a flowchart showing details of the load information acquisition process shown in step S01 in FIG. 3. In FIG. 3, step S02 is a message reception check step, step S03 is a stop condition check step, step S04 is a reception stop step, step S05 is a restart condition check step, and step S06 is a reception restart step. In FIG. 4, step S11 is a processing load information acquisition step, step S12 is a reception load information acquisition step, and step S13 is a load information output step.

In step S01 in FIG. 3, the load information acquisition process is executed by the load state monitoring unit 5, and the process proceeds to step S02. The load information acquisition process will be described in detail with reference to FIG. 4. In step S11, the load state monitoring unit 5 acquires the processing load information which is load information of the application processing unit 4, from the application processing unit 4, and the process proceeds to step S12. The processing load information includes, for example, a processing CPU utilization which is a CPU utilization of the application processing unit 4. In step S12, the load state monitoring unit 5 acquires the reception load information which is load information of the other-vehicle information reception unit 2, from the other-vehicle information reception unit 2, and the process proceeds to step S13, The reception load information includes an empty buffer amount which is an empty capacity of the reception buffer 3. The reception load information may include a reception CPU utilization which is a CPU utilization of the other-vehicle information reception unit 2, with the empty buffer amount. In addition, the reception load information may include a message processing time period taken by the other-vehicle information reception unit 2 to process one message, with the empty buffer amount. In step S13, the load state monitoring unit 5 outputs the acquired processing load information and the acquired reception load information to the reception control unit 6, and the load information acquisition process ends. In the load information acquisition process, step S12 may be executed without execution of step S11, and the load state monitoring unit 5 may output only the acquired reception load information to the reception control unit 6 in step S13.

In step S02 in FIG. 3, the reception control unit 6 checks whether or not the reception unit 11 is receiving messages from the outside of the vehicle. If the reception unit 11 is receiving messages, the process proceeds to step S03, and, if the reception unit 11 has stopped receiving messages, the process proceeds to step S05. For example, in step S02: the reception stop determination unit 61 checks whether or not the reception unit 11 is receiving messages from outside of the vehicle, and, if the reception unit 11 is receiving messages, the process proceeds to step S03; and the reception restart determination unit 62 checks whether or not the reception unit 11 has stopped receiving messages, and, if the reception unit 11 has stopped receiving messages, the process proceeds to step S05.

In step S03, the reception stop determination unit 61 checks whether or not the reception load information and the processing load information acquired from the load state monitoring unit 5 satisfy the stop condition. If the stop condition is satisfied, the process proceeds to step S04, and, if the stop condition is not satisfied, the reception control process ends. In a case where the reception stop determination unit 61 acquires only the reception load information from the load state monitoring unit 5, in step

S03, the reception stop determination unit 61 checks whether or not the reception load information acquired from the load state monitoring unit 5 satisfies the stop condition. If the stop condition is satisfied, the process proceeds to step S03, and, if the stop condition is not satisfied, the reception control process ends. For example, in a case where the reception load information includes the empty buffer amount which is an empty capacity of the reception buffer 3, in step S03: in the reception stop determination unit 61, if the value of the empty buffer amount is less than a reference capacity which is a capacity to be used to receive messages for one cycle of the out-of-vehicle communication cycle, the process may proceed to step S04; and, if the empty buffer amount is not less than the reference capacity, the reception control process may end. In step S04, the reception stop determination unit 61 outputs the reception stop signal to the reception unit 11, the reception unit 11 which has acquired the reception stop signal stops receiving messages until it acquires the reception restart signal, and the reception control process ends.

In step S05, the reception restart determination unit 62 checks whether or not the reception load information and the processing load information acquired from the load state monitoring unit 5 satisfy the restart condition. If the restart condition is satisfied, the process proceeds to step S06, and, if the restart condition is not satisfied, the reception control process ends. In a case where the reception restart determination unit 62 acquires only the reception load information from the load state monitoring unit 5, in step S05, the reception restart determination unit 62 checks whether or not the reception load information acquired from the load state monitoring unit 5 satisfies a restart condition. If the restart condition is satisfied, the process proceed to step S06, and, if the restart condition is not satisfied, the reception control process ends. For example, in a case where the reception load information includes the empty buffer amount which is an empty capacity of the reception buffer 3, in step S05: in the reception restart determination unit 62, if the value of the empty buffer amount included in the reception load information is not less than the reference capacity, the process may proceed to step S06; and if the value of the empty buffer amount is less than the reference capacity, the reception control process may end. In step S06, the reception restart determination unit 62 outputs the reception restart signal to the reception unit 11, the reception unit 11 which has acquired the reception restart signal restarts receiving messages, and the reception control process ends.

Through the above process, the reference capacity which is a capacity to be used to receive messages for one cycle of the out-of-vehicle communication cycle can be always ensured in the reception buffer 3, even if the number of surrounding vehicles is increased and the amount of received messages is increased, and at least the messages for one cycle can be stored in the reception buffer 3 after reception is restarted. Therefore, random loss of messages does not happen.

The reference capacity may be, for example, a value obtained by multiplying a maximum reception rate of the reception unit 11 by the out-of-vehicle communication cycle. For example, when the out-of-vehicle communication cycle is set at 100 ms, the reference capacity corresponds to a data amount that can be received by the reception unit 11 in 100 ms. Since the reference capacity is the value obtained by multiplying the maximum reception rate of the reception unit 11 by the out-of-vehicle communication cycle, the messages for one cycle can be stored in the reception buffer 3, even if the reception unit 11 receives messages at the maximum reception rate of the reception unit 11 after reception is restarted. The reference capacity may be a value obtained by multiplying the maximum reception rate of the reception unit 11 by the out-of-vehicle communication cycle, and further multiplying a resultant value by α that is 1 or more. Owing to further multiplying by α, a margin for buffer processing can be ensured.

The reference capacity may be, for example, a value obtained by multiplying an average reception rate of the reception unit 11 over a past predetermined time period by the out-of-vehicle communication cycle. For example, when the out-of-vehicle communication cycle is set at 100 ms, the reference capacity may be a value obtained by dividing, by 10, a data amount received by the reception unit 11 for one second in the past. Since the reference capacity is the value obtained by multiplying the average reception rate of the reception unit 11 over the past predetermined time period by the out-of-vehicle communication cycle, reception can be stopped/restarted according to a past reception state, and, for example, in a case where the amount of messages received in the past is small, a time taken until reception is restarted after reception has been stopped can be further shortened. The reference capacity may be a value obtained by multiplying the average reception rate of the reception unit 11 over the past predetermined time period by the out-of-vehicle communication cycle, and further multiplying a resultant value by α that is 1 or more. Owing to further multiplying by α, a margin for buffer processing can be ensured.

The reference capacity may be, for example, a value obtained by subtracting a readout rate at which the other-vehicle information reception unit 2 reads and processes the messages from the reception buffer 3, from the average reception rate of the reception unit 11 over the past predetermined time period, and multiplying a resultant value by the out-of-vehicle communication cycle. Since the reference capacity is the value obtained by subtracting the readout rate at which the other-vehicle information reception unit 2 reads and processes the messages from the reception buffer 3, from the average reception rate of the reception unit 11 over the past predetermined time period, and multiplying a resultant value by the out-of-vehicle communication cycle, reception can be stopped/restarted according to a past reception state and a past processing state, and, for example, in a case where the amount of messages received in the past is small and the past message processing rate is high, a time taken until reception is restarted after reception has been stopped can be further shortened. The reference capacity may be a value obtained by subtracting the readout rate at which the other-vehicle information reception unit 2 reads and processes the messages from the reception buffer 3, from the average reception rate of the reception unit 11 over the past predetermined time period, multiplying a resultant value by the out-of-vehicle communication cycle, and then further multiplying a resultant value by α that is 1 or more, Owing to further multiplying by α, a margin for buffer processing can be ensured.

Further, for example, the reception load information may include the processing CPU utilization which is a CPU utilization of the other-vehicle information reception unit 2, and the processing load information may include the processing CPU utilization which is a CPU utilization of the application processing unit 4. Then, in step S03, in the reception stop determination unit 61, if a value obtained by adding the processing CPU utilization to the reception CPU utilization exceeds a predetermined reference CPU utilization, the process may proceed to step S04. When the value obtained by adding the processing CPU utilization to the reception CPU utilization exceeds the predetermined reference CPU utilization, reception of messages in the reception unit 11 is stopped, so that a processing load of CPU can be reduced and an empty capacity of the reception buffer 3 can be increased.

Further, for example, the reception load information may include the message processing time period taken by the other-vehicle information reception unit 2 to process one message, and then, in step S03, in the reception stop determination unit 61, if the message processing time period exceeds a predetermined reference processing time period, the process may proceed to step S04. When the message processing time period exceeds the predetermined reference processing time period, reception of messages in the reception unit 11 is stopped, so that an empty capacity of the reception buffer 3 can be increased when a time is taken for processing the messages.

As described above, the vehicle-mounted communication device 100 according to embodiment 1 includes: the reception unit 11 for receiving messages transmitted per out-of-vehicle communication cycle from the outside of the vehicle; the other-vehicle information reception unit 2 for acquiring the messages from the reception unit 11 and extracting the other-vehicle information from the messages; the reception buffer 3 in which the messages acquired by the other-vehicle information reception unit 2 are temporarily stored; the load state monitoring unit 5 for acquiring the reception load information which is load information of the other-vehicle information reception unit 2, from the other-vehicle information reception unit 2; and the reception control unit 6 for acquiring the reception load information from the load state monitoring unit 5 and controlling the reception unit 11. The reception control unit 6 includes the reception stop determination unit 61 for determining whether or not the reception unit 11 should stop reception, and the reception restart determination unit 62 for determining whether or not the reception unit 11 should restart reception. The reception load information includes the empty buffer amount which is an empty capacity of the reception buffer 3. The reception stop determination unit 61 outputs the reception stop signal to the reception unit 11, if the reception unit 11 is receiving the messages and the empty buffer amount is less than the reference capacity which is a capacity to be used to receive the messages for one cycle of the out-of-vehicle communication cycle. The reception restart determination unit 62 outputs the reception restart signal to the reception unit 11, if the reception unit 11 has stopped receiving the messages and the empty buffer amount is not less than the reference capacity. When the reception unit 11 has acquired the reception stop signal while receiving the messages, the reception unit 11 stops receiving the messages, and when reception unit 11 has acquired the reception restart signal during stop of receiving the messages, the reception unit 11 restarts receiving the messages. Therefore, loss of received messages which randomly happens can be prevented.

### Embodiment 2

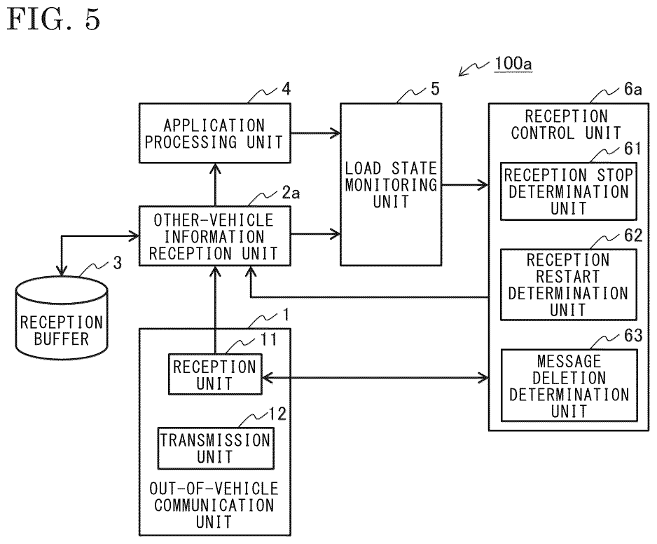

FIG. 5 is a block diagram showing a configuration of a vehicle-mounted communication device 100a according to embodiment 2. In the vehicle-mounted communication device 100a according to embodiment 2 shown in FIG. 5, as compared to the vehicle-mounted communication device 100 according to embodiment 1 shown in FIG. 2, the other-vehicle information reception unit 2 is replaced with an other-vehicle information reception unit 2a, and the reception control unit 6 is replaced with a reception control unit 6a. The other-vehicle information reception unit 2a has the same function as the other-vehicle information reception unit 2, and further has a function described below. The other configurations of the vehicle-mounted communication device 100a according to embodiment 2 are the same as those of the vehicle-mounted communication device 100 according to embodiment 1.

The reception control unit 6a includes a message deletion determination unit 63 for determining whether or not the messages stored in the reception buffer 3 should be deleted. The message deletion determination unit 63 acquires the reception load information including information on the empty buffer amount which is an empty capacity of the reception buffer 3, from the load state monitoring unit 5, and outputs a message deletion signal to the other-vehicle information reception unit 2a, if the empty buffer amount is less than a predetermined deletion reference capacity. When the other-vehicle information reception unit 2a has acquired the message deletion signal from the message deletion determination unit 63, the other-vehicle information reception unit 2a deletes a predetermined deletion data amount of the messages in order from the oldest message of the messages stored in the reception buffer 3.

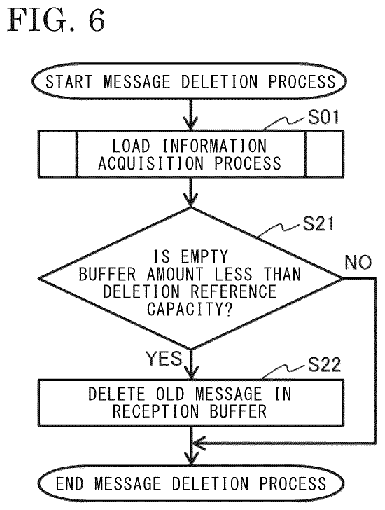

FIG. 6 is a flowchart showing details of a message deletion process in the vehicle-mounted communication device 100a according to embodiment 2. In FIG. 6, step S01 is the load information acquisition process, and is the same as step S01 shown in FIG. 2. Details of the load information acquisition process are shown in FIG. 4. Step S21 is an empty buffer amount check step, and step S22 is a message deletion step.

In step S21, the message deletion determination unit 63 acquires the information on the empty buffer amount from the reception load information acquired from the load state monitoring unit 5 in step S01, and checks whether or not the value of the empty buffer amount is less than the predetermined deletion reference capacity. If the empty buffer amount is less than the deletion reference capacity, the process proceeds to step S22, and, if the empty buffer amount is not less than the deletion reference capacity, the message deletion process ends. In step S22, the message deletion determination unit 63 outputs the message deletion signal to the other-vehicle information reception unit 2a. The other-vehicle information reception unit 2a which has acquired the message deletion signal deletes the predetermined deletion data amount of the messages in order from the oldest message of the messages stored in the reception buffer 3, and the message deletion process ends. Through the above process, the old messages in the reception buffer 3 can be deleted before the reception buffer 3 becomes full, and, therefore, loss of messages newly received can be prevented.

The deletion data amount may be, for example, the value obtained by multiplying the maximum reception rate of the reception unit 11 by the out-of-vehicle communication cycle. For example, when the out-of-vehicle communication cycle is set at 100 ms, the deletion data amount corresponds to a data amount that can be received by the reception unit 11 in 100 ms. Since the deletion data amount is the value obtained by multiplying the maximum reception rate of the reception unit 11 by the out-of-vehicle communication cycle, the messages for one cycle can be stored in the reception buffer 3 after the old messages are deleted, even if the reception unit 11 receives messages at the maximum reception rate of the reception unit 11. The deletion data amount may be the value obtained by multiplying the maximum reception rate of the reception unit 11 by the out-of-vehicle communication cycle, and further multiplying a resultant value by x that is 1 or more. Owing to further multiplying by, a margin for buffer processing can be ensured.

The deletion data amount may be, for example, the value obtained by multiplying an average reception rate of the reception unit 11 over a past predetermined time period by the out-of-vehicle communication cycle. For example, when the out-of-vehicle communication cycle is set at 100 ms, the deletion data amount may be a value obtained by dividing, by 10, a data amount received by the reception unit 11 for one second in the past. Since the deletion data amount is the value obtained by multiplying the average reception rate of the reception unit 11 over the past predetermined time period by the out-of-vehicle communication cycle, the number of messages to be deleted can be decreased in a case where the amount of messages received in the past is small. The deletion data amount may be a value obtained by multiplying the average reception rate of the reception unit 11 over the past predetermined time period by the out-of-vehicle communication cycle, and further multiplying a resultant value by α that is 1 or more. Owing to further multiplying by α, a margin for buffer processing can be ensured.

The deletion data amount may be, for example, a value obtained by subtracting a readout rate at which the other-vehicle information reception unit 2a reads and processes the messages from the reception buffer 3, from the average reception rate of the reception unit 11 over the past predetermined time period, and multiplying a resultant value by the out-of-vehicle communication cycle. Since the deletion data amount is the value obtained by subtracting the readout rate at which the other-vehicle information reception unit 2a reads and processes the messages from the reception buffer 3, from the average reception rate of the reception unit 11 over the past predetermined time period, and multiplying a resultant value by the out-of-vehicle communication cycle, the number of messages to be deleted can be decreased in a case where the amount of the messages received in the past is small and the amount of messages read in the past is large, The deletion data amount may be a value obtained by subtracting the readout rate at which the other-vehicle information reception unit 2a reads and processes the messages from the reception buffer 3, from the average reception rate of the reception unit 11 over the past predetermined time period, multiplying a resultant value by the out-of-vehicle communication cycle, and then further multiplying a resultant value by α that is 1 or more. Owing to further multiplying by α, a margin for buffer processing can be ensured.

As described above, in the vehicle-mounted communication device 100a according to embodiment 2, the reception control unit 6a includes the message deletion determination unit 63 for determining whether or not the messages stored in the reception buffer 3 should be deleted. The message deletion determination unit 63 outputs the message deletion signal to the other-vehicle information reception unit 2a, if the empty buffer amount is less than the predetermined deletion reference capacity. When the other-vehicle information reception unit 2a has acquired the message deletion signal, the other-vehicle information reception unit 2a deletes the predetermined deletion data amount of the messages in order from the oldest message of the messages stored in the reception buffer 3. Through the above process, the old messages in the reception buffer 3 can be deleted before the reception buffer 3 becomes full, and, therefore, loss of messages newly received can be prevented.

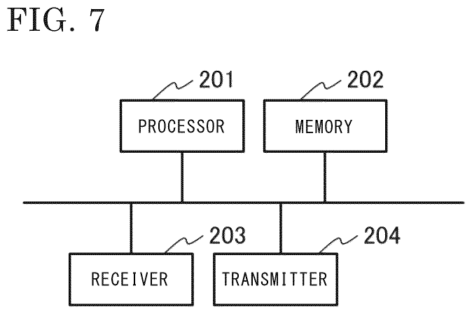

FIG. 7 is a schematic view showing an example of a hardware configuration of the vehicle-mounted communication device according to embodiment 1 and embodiment 2. Each of the other-vehicle information reception unit 2, 2a, the application processing unit 4, the load state monitoring unit 5, the reception control unit 6, 6a, the reception stop determination unit 61, the reception restart determination unit 62, and the message deletion determination unit 63 is implemented by a processor 201 such as a central processing unit (CPU) which executes a program stored in a memory 202. The memory 202 is used also as a transitory storage device for each type of processing to be executed by the processor 201. Also, a plurality of processing circuits may execute the above functions in cooperation. Further, the above functions may be implemented by dedicated hardware. In the case where the functions are realized by dedicated hardware, the dedicated hardware is, for example, a single circuit, a complex circuit, a programmed processor, an ASIC, an FPGA, or a combination thereof. The above functions may be implemented by a combination of the dedicated hardware and software or a combination of the dedicated hardware and firmware. The memory 202 is, for example, a nonvolatile or volatile semiconductor memory such as a RAM, a ROM, a flash memory, or an EPROM, a magnetic disk, an optical disc, or a combination thereof. The reception buffer 3 is implemented by the memory 202. The reception unit 11 is implemented by a receiver 203, and the transmission unit 12 is implemented by a transmitter 204. The processor 201, the memory 202, the receiver 203, and the transmitter 204 are connected to each other by a bus.

Although the disclosure is described above in terms of various exemplary embodiments, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 out-of-vehicle communication unit
2, 2a other-vehicle information reception unit
3 reception buffer
4 application processing unit
5 load state monitoring unit
6, 6a reception control unit
11 reception unit
12 transmission unit
61 reception stop determination unit
62 reception restart determination unit
63 message deletion determination unit
100, 100a vehicle-mounted communication device
101 own vehicle
102 other vehicle
201 processor
202 memory
203 receiver
204 transmitter

1. A vehicle-mounted communication device comprising:
a reception circuitry to receive messages transmitted per out-of-vehicle communication cycle from outside of a vehicle;
an other-vehicle information reception circuitry to acquire the messages from the reception circuitry and extracting other-vehicle information from the messages;
a reception buffer in which the messages acquired by the other-vehicle information reception circuitry are temporarily stored;
a load state monitoring circuitry to acquire reception load information which is load information of the other-vehicle information reception circuitry, from the other-vehicle information reception circuitry; and
a reception control circuitry to acquire the reception load information from the load state monitoring circuitry and controlling the reception circuitry, wherein
the reception control circuitry includes a reception stop determination circuitry to determine whether or not the reception circuitry should stop reception, and a reception restart determination circuitry to determine whether or not the reception circuitry should restart reception,
the reception load information includes an empty buffer amount which is an empty capacity of the reception buffer,
the reception stop determination circuitry outputs a reception stop signal to the reception circuitry, if the reception circuitry is receiving the messages and the empty buffer amount is less than a reference capacity which is a capacity to be used to receive the messages for one cycle of the out-of-vehicle communication cycle,
the reception restart determination circuitry outputs a reception restart signal to the reception circuitry, if the reception circuitry has stopped receiving the messages and the empty buffer amount is not less than the reference capacity, and
when the reception circuitry has acquired the reception stop signal while receiving the messages, the reception circuitry stops receiving the messages, and when the reception circuitry has acquired the reception restart signal during stop of receiving the messages, the reception circuitry restarts receiving the messages.

2. The vehicle-mounted communication device according to claim 1, wherein
the reference capacity is a value obtained by multiplying a maximum reception rate of the reception circuitry by the out-of-vehicle communication cycle.

3. The vehicle-mounted communication device according to claim 1, wherein
the reference capacity is a value obtained by multiplying an average reception rate of the reception circuitry over a past predetermined time period by the out-of-vehicle communication cycle.

4. The vehicle-mounted communication device according to claim 1, wherein
the reference capacity is a value obtained by subtracting a readout rate at which the other-vehicle information reception circuitry reads and processes the messages from the reception buffer, from an average reception rate of the reception circuitry over a past predetermined time period, and multiplying a resultant value by the out-of-vehicle communication cycle.

5. The vehicle-mounted communication device according to claim 1, further comprising an application processing circuitry to perform processing for an application on the basis of the other-vehicle information, wherein
the load state monitoring circuitry acquires processing load information which is load information of the application processing circuitry, from the application processing circuitry,
the reception control circuitry acquires the processing load information from the load state monitoring circuitry,
the reception load information includes a reception CPU utilization which is a CPU utilization of the other-vehicle information reception circuitry,
the processing load information includes a processing CPU utilization which is a CPU utilization of the application processing circuitry, and
the reception stop determination circuitry outputs the reception stop signal to the reception circuitry, if the reception circuitry is receiving the messages and a value obtained by adding the processing CPU utilization to the reception CPU utilization exceeds a predetermined reference CPU utilization.

6. The vehicle-mounted communication device according to claim 1, wherein
the reception load information includes a message processing time period taken by the other-vehicle information reception circuitry to process one of the messages, and
the reception stop determination circuitry outputs the reception stop signal to the reception circuitry, if the reception circuitry is receiving the messages and the message processing time period exceeds a predetermined reference processing time period.

7. The vehicle-mounted communication device according to claim 1, wherein
the reception control circuitry includes a message deletion determination circuitry to determine whether or not the messages stored in the reception buffer should be deleted,
the message deletion determination circuitry outputs a message deletion signal to the other-vehicle information reception circuitry, if the empty buffer amount is less than a predetermined deletion reference capacity, and
when the other-vehicle information reception circuitry has acquired the message deletion signal, the other-vehicle information reception circuitry deletes a predetermined deletion data amount of the messages in order from the oldest message of the messages stored in the reception buffer.

8. The vehicle-mounted communication device according to claim 7, wherein
the deletion data amount is a value obtained by multiplying a maximum reception rate of the reception circuitry by the out-of-vehicle communication cycle.

9. The vehicle-mounted communication device according to claim 7, wherein
the deletion data amount is a value obtained by multiplying an average reception rate of the reception circuitry over a past predetermined time period by the out-of-vehicle communication cycle.

10. The vehicle-mounted communication device according to claim 7, wherein
the deletion data amount is a value obtained by subtracting a readout rate at which the other-vehicle information reception circuitry reads and processes the messages from the reception buffer, from an average reception rate of the reception circuitry over a past predetermined time period, and multiplying a resultant value by the out-of-vehicle communication cycle.
